(19) United States
(12) Patent Application Publication
(10) Pub. No.: US 2014/0265473 A1
(43) Pub. Date: Sep. 18, 2014

(54) CAR SEAT FOR PROTECTING VERTEBRAL COLUMN

(71) Applicant: FORSOUND CORP., Kaohsiung (TW)

(72) Inventor: Fu-Chieng CHEN, Kaohsiung (TW)

(73) Assignee: FORSOUND CORP., Kaohsiung (TW)

(21) Appl. No.: 13/826,510

(22) Filed: Mar. 14, 2013

(51) Int. Cl. B60N 2/42

(52) U.S. Cl. CPC B60N 2/4249
USPC 297/216.13

(57) ABSTRACT

Disclosed is a car seat for protecting vertebral column, comprising: a backrest and a seat, wherein there is disposed with a troughed recess at a central portion of each of the backrest and the seat, so that when the backrest and the seat are subject to external impact, the impact damage incurred by the backrest and the seat onto a human vertebral column may be avoided, and in this way the human vertebral column can therefore be protected; in an embodiment of the present invention, there further comprises a plurality of viscous elastomers disposed inside the backrest and the seat, these viscous elastomers are set up in a corresponding arrangement on two sides of a human vertebral column, so as to assist in biasing the muscle on the two sides of the vertebral column to cause less direct impact by the external force, and to provide a cushioning effect.

### BACKGROUND OF THE INVENTION

1. Field of the Invention

The present invention relates to an apparatus for use in car seat, particularly for applications in cars, RVs, trucks, buses, container trucks, and other types of vehicles, for the purpose of securing safety of human vertebral column through the means of car seat.

2. Description of Related Art

Car continues to be a dominant mode of transportation for the modern society, and accounts for the most used vehicle for most people. The major function of a car seat aims to provide the rider a place to sit when riding a car, and in consideration of safety, car makers or car seat makers also spend a great amount of attention in taking deliberation in the safety of car seat, and its protection aspect for the riders.

In most car safety accidents, the main cause of casualty to passengers is due to the impact or collision against an external force, which leads to physical damage to human bodies, and the impact or collision affected on a human body can include collision by a human body to an object, or an object to a human body. The former situation can be avoided by using a safety belt to keep the passenger in a fixed position in the car seat, and for the latter there are many known techniques that can be used to protect the passengers from harm, for examples, air bags for cars, car seats and pillows capable of cushioning effect, in particular, pillow of car seat can also provide support to a person's neck, while also keep the neck from serious harm when the car is subject to external force collision from behind.

FIG. 1 herewith shows the anatomical structure of a human vertebral column. From a side perspective, the vertebral column has a visual appearance of a “S shape”, including seven cervical vertebrae, twelve thoracic and five lumbar, one of sacrum and caudal below a lumbar. The structure of vertebral column resembles a circular column, connects to medulla, and extends from the foramen magnum to the location of the second lumbar. It is a thick nerve bundle, works to deliver information between the brain proper and other parts of the body, it meets the brain at the base of the skull, extends downward along the channel formed by the foramen. Muscle, blood vessels, and nerves are located in front and on two sides of the spine; the main function of the spine includes: supporting weight; guiding gravity so as to maintain body balance; and protecting spinal cord and nerve root to permit the brain to deliver information, or to accept information, and also protecting the neural system at the same time.

As shown in FIG. 2, under normal situations, when a passenger is in the car seat, the vertebral column 40 of a human body's back will collapse between the back muscles 41 on the two sides, the backrest 70 will be given priority to contact the back muscles 41 on the two sides of the vertebral column 40, the strength of the back is supported by the back muscle 41 on the two sides of the vertebral column 40. When the posture changes, especially when the car driver stretches arms to take command of the driver's wheel (as shown in FIG. 3), the back muscle 41 originally on the two sides of the vertebral column 40 will stretch toward the two sides, the vertebral column 40 on the back will at this time appear to be more protruding and will touch the back surface of the backrest 70. In this case, if the car is subject to considerable external force impact or collision, the backrest 70 will very likely cause a great deal of impact or collision to the back of the human body, and directly cause damages to the vertebral column 40.

### SUMMARY OF THE INVENTION

The present invention aims to provide a car seat for protecting vertebral column of a human body, which comprises a backrest and a sea, a portion that is close to the central portion of the backrest and the seat and corresponds a vertebral column of a human figure has a troughed recess.

In a preferred embodiment, the recess is located on a surface of a cushioning material that is made to comprise the backrest and the seat.

In another preferred embodiment, the cushioning material of the backrest and the seat is covered on their surface by a covering layer, the covering layer is thoroughly attached to the surface of the cushioning material and the recess, making the shape of the troughed recess visible at the position corresponding to the covering layer of the backrest and the seat.

In yet another embodiment of the present invention, the cushioning material for the backrest and the seat further comprises a covering layer, the covering layer works to cover upon the recess, the covering layer of the backrest and the seat work to present a planar surface at the position corresponding to the recess.

Another object of the present invention is to provide a car seat for protecting vertebral column, which comprises a backrest and a seat, the backrest and the seat are at least composed of a cushioning material, and a troughed recess is created near a central portion of the cushioning material that corresponds to a human vertebral column; a plurality of viscous elastomers, the viscous elastomer is disposed on the two sides of the troughed recess of the cushioning material of the backrest or the seat, and corresponds to the two sides of the human vertebral column.

In a preferred embodiment, the cushioning material of the backrest and the seat is covered on its outside by a covering layer, the covering layer is thoroughly attached to the surface of the cushioning material and the recess, making the shape of the troughed recess visible at the position of the backrest and the seat corresponding to the recess.

In another preferred embodiment, the cushioning material of the backrest and the seat are covered on its outside by a covering layer, the covering layer covers upon the recess, the covering layer of the backrest and the seat presents a planar surface at a position corresponding to the recess.

In a preferred embodiment, the viscous elastomer is made by a solid gel.

In yet another preferred embodiment, the viscous elastomer is made by a TPU.

Details of other functions and embodiments of the present invention will be described hereunder with the drawings.

### BRIEF DESCRIPTION OF THE DRAWINGS

### Prior Arts

FIG. 1 is side anatomical view of a human vertebral column.

FIG. 2 shows a situation in which a human back reposes on a backrest, demonstrating the manner in which a vertebral column collapses between back muscles on two sides under normal conditions.

FIG. 3 shows a situation in which a human back reposes on a backrest, demonstrating the protruding appearance of the vertebral column and its contact with the backrest's surface when the subject stretches his/her arms.

### Present Invention

FIG. 4 shows cross-sectional view of an embodiment of the car seat for protecting vertebral column according to the present invention.

FIG. 5 shows the perspective view of an embodiment of the car seat for protecting vertebral column according to the present invention.

FIG. 6 shows the perspective view of another embodiment of the car seat for protecting vertebral column according to the present invention.

FIG. 7 is a diagram showing the use of a car seat for protecting vertebral column according to the present invention, demonstrating the communicating relationship between the human vertebral column and the recess.

FIG. 8 is a diagram showing the use of a car seat for protecting vertebral column of the present invention, demonstrating the manner by which the human vertebral column collapses into the recess.

FIG. 9 is a diagram showing the use of the car seat for protecting vertebral column of the present invention.

FIG. 10 shows a diagram for appearance structure of another embodiment of the car seat for protecting vertebral column of the present invention.

FIGS. 11A and 11B show a diagram for appearance structure of another embodiment of the car seat for protecting vertebral column of the present invention.

### DETAILED DESCRIPTION OF THE PREFERRED EMBODIMENT

Referring now to FIG. 4, a structure for an embodiment for the car seat for protecting vertebral column of the present invention is disclosed, the car seat comprises: a backrest 10 and a seat 20, the backrest 10 and the seat 20 are composed of a cushioning material and a scaffold, wherein there is disposed with a troughed recess 30 at a position of the backrest 10 and seat 20 corresponding to a human vertebral column 40 (see FIG. 7), a mode of manufacturing for the recess 30 is direct molding or cast molding on a surface of the cushioning material M of the backrest 10 and seat 20, generally speaking, cushioning material M is usually a foam. Therefore, an embodiment of the present invention is to form a backrest 10 and seat 20 from a foam while at the same time directly form a recess 30 at a predetermined location by an integrated molding fashion. The recess 30 can extend on the backrest 10 along a human vertebral column 40 and downward a position on the seat 20 corresponding to the pubis bone, when a human body is in a car seat, the arrangement can let the human vertebral column 40 to correspond to the recess 30, allowing the vertebral column 40 to collapse into the recess 30 (see FIG. 8 and FIG. 9), while keeping the backrest 10 and seat 20 from direct contact; even when the backrest 10 and the seat 20 are subject to collision of an external force, the arrangement can prevent the backrest 10 and the seat 20 from directly colliding against the human vertebral column 40, and further providing protection to the vertebral column 40.

In an embodiment of the present invention, the outside of the cushioning material M of the backrest 10 and seat 20 is covered by a covering layer 50, the material of the covering layer 50 can be selected from any of a fabric, a natural leather or a man-made leather, in an embodiment herein, the covering layer 50 is thoroughly attached onto the surface of the cushioning material M and the recess 30, making the shape of the troughed recess 30 still visible at the position of the covering layer 50 corresponding to the backrest 10 and the seat 20 (see FIG. 5); in another embodiment of the present invention, the covering layer 50 covers upon the recess 30, from a perspective view, the covering layer 50 of the backrest and the seat 20 presents a planar surface at a position corresponding the recess 30. (See FIG. 6).

FIG. 10 shows the structure of another embodiment of the car seat for protecting vertebral column of the present invention, which comprises a plurality of viscous elastomers 60 disposed on the backrest 10 and seat 20, these viscous elastomers 60 are disposed on the surface of the cushioning material M of the backrest 10 or seat 20, and are located on the two sides of the troughed recess of the backrest 10 or seat 20, and corresponds to the two sides of the vertebral column 40. The viscous elastomers 60 can be solid gels or thermoplastic polyurethane (also known as TPU); the solid gels can be a polymer compound having excellent pressure dispensing and impact force absorbability, and can also be a copolymer, which can be thermoplastic, for example, it can be SEBS (hydrogenated styrene-butadiene-styrene block copolymer), and can be mixed processing with mineral oil work to form a flexible elastic colloid. Also, the hardness of solid gel can be adjusted depending on its demand, it can have low resilience so can be especially adaptable for making highly soft cushions, and can be made to assist the muscles on the two sides of the vertebral column 40 to protect the vertebral column 40 to make direct collision by external force less likely and to provide pressure buffering effect.

The TPU is an environmentally protective material; it does not contain plasticizers, and is characterized between rubber and plastic. Among the currently known rubber and plastic materials, the TPU has the most desirable physical property in terms of impact sustainability, bending sustainability, high extension sustainability, high anti-tearing strength and low temperature sustainability, and others.

As shown in FIG. 11A, the surfaces of the viscous elastomers 60, solid gels, or TPU are approximately at the same level as the surfaces of the backrest 10 or seat 20.

As shown in FIG. 11B, the surfaces of the viscous elastomers 60, solid gels, or TPU protrude from the surfaces of the backrest 10 or seat 20.

Although the present invention has been disclosed as the embodiments described above, those skilled in the art will appreciate that the conception may readily be utilized as a basis for the designing of other structures, methods and systems for carrying out the several purposes of the present invention without departing from the spirit and scope of the present invention. Therefore the claims of the patent for the present invention shall be governed by the claims appended herewith in the current specification.

What is claimed is:

1. A car seat for protecting vertebral column, comprising:
a backrest and a seat, wherein the backrest and the seat have a first surface and a second surface and are at least composed of a cushioning material, and a portion near a center of cushioning material that corresponds to a human vertebral column is disposed with a troughed recess; and
a plurality of viscous elastomers disposing on two sides of the recess of the cushioning material of the backrest and the seat, and corresponding to two sides of the human vertebral column.

2. The car seat for protecting vertebral column of claim 1, wherein the cushioning material of the backrest and the seat is covered on the outside by a covering layer, the covering layer is thoroughly attached on a surface of the cushioning material and the recess, such that a shape of the troughed recess remains visible through the covering layer at a position corresponding to the backrest and the seat.

3. The car seat for protecting vertebral column of claim 1, further comprising a covering layer covering the outside of the cushioning material of the backrest and the seat, wherein the covering layer covers upon the recess, a portion of the covering layer of the backrest and the seat communicate with the recess to present a planar surface.

4. The car seat for protecting vertebral column of claim 1, wherein each of the plurality of viscous elastomers has a first surface and a second surface, and the first surfaces of the plurality of viscous elastomers are at the same level as the first surface of the backrest or seat.

5. The car seat for protecting vertebral column of claim 1, wherein each of the plurality of viscous elastomers has a first surface and a second surface, and the first surfaces of the plurality of viscous elastomers protrude from the first surface of the backrest or seat.

6. The car seat for protecting vertebral column of claim 1, wherein the viscous elastomers are made of solid gels.

7. The car seat for protecting vertebral column of claim 6, wherein the solid gels can be made of polymer compounds having excellent pressure dispensing and impact force absorbability, and can be made of a copolymer, which is a flexibly elastic gel formed by SEBS (hydrogenated styrene-butadiene-styrene) mixed processing with mineral oil.

8. The car seat for protecting vertebral column of claim 6, wherein each of the solid gels has a first surface and a second surface, and the first surfaces of the solid gels are at the same level as the first surface of the backrest or seat.

9. The car seat for protecting vertebral column of claim 6, wherein each of the solid gels has a first surface and a second surface, and the first surfaces of the solid gels protrude from the first surface of the backrest or seat.

10. The car seat for protecting vertebral column of claim 1, wherein the viscoelastic entities are made of TPU.

11. The car seat for protecting vertebral column of claim 10, wherein the TPU has a first surface and a second surface, and the first surface of the TPU is at the same level as the first surface of the backrest or seat.

12. The car seat for protecting vertebral column of claim 10, wherein the TPU has a first surface and a second surface, and the first surface of the TPU protrudes from the first surface of the backrest or seat.
